(19) United States
(12) Patent Application Publication
(10) Pub. No.: US 2021/0057140 A1
(43) Pub. Date: Feb. 25, 2021

(54) REACTOR AND COIL CASE

(71) Applicant: Fanuc Corporation, Minamitsuru-gun (JP)

(72) Inventor: Masatomo Shirouzu, Minamitsuru-gun (JP)

(73) Assignee: Fanuc Corporation, Minamitsuru-gun (JP)

(21) Appl. No.: 16/940,653

(22) Filed: Jul. 28, 2020

(30) Foreign Application Priority Data
Aug. 22, 2019 (JP) 2019-152042

(51) Int. Cl. H01F 27/26; H01F 3/14; H01F 27/28

(52) U.S. Cl. CPC H01F 27/263; H01F 27/2823; H01F 3/14

(57) ABSTRACT

A reactor includes an outer peripheral iron core and at least three iron core coils. The iron core coil includes an iron core and a coil. The coil is configured by a flat wire that is wound at least once. The reactor includes a temperature detector provided to be in surface contact with a wide face of a flat wire that constitutes the coil.

### BACKGROUND OF THE INVENTION

### 1. Field of the Invention

The present invention relates to a reactor and a coil case.

### 2. Description of the Related Art

In recent years, a reactor has been developed that includes a core body having an outer peripheral iron core and a plurality of iron cores disposed inside the outer peripheral iron core. A coil is mounted on each of the plurality of iron cores. See, for example, JP 2017-139438 A.

Further, JP 2019-004066 A discloses a reactor that includes a temperature detector disposed at a center of one end face of a core main body.

### SUMMARY OF THE INVENTION

Incidentally, in a case where interlayer short-circuit occurs in a coil of one phase in a reactor, a larger current flows therethrough than in a coil of another phase. When this condition continues, a temperature of the coil rises higher than an assumed temperature, hence, the temperature of the coil may exceed a heat resistance temperature of an insulating member around the coil, whereby performance of the insulating member may be deteriorated earlier and a ground fault may occur. Thus, it is necessary to detect the interlayer short-circuit at an early stage by promptly detecting the temperature of the coil in order to protect the reactor before occurrence of deterioration of the insulating member around the coil due to heat.

Normally, the reactor generates heat in coils and iron cores, and when a power source frequency is low, the rate of heat build-up in the coils tends to be larger, and when the power source frequency is high, the rate of heat build-up in the iron cores tends to be larger. At a commercial power source frequency of 50 Hz or 60 Hz, the rate of heat build-up in the coils is larger. Then, in accordance with an increase in the temperature of the coils, the temperature of the reactor tends to increase. Thus, when a power source frequency is low, it is particularly important to monitor a temperature change of the coil. However, since the temperature detector in JP2019-004066A is provided at a center of an end face of a core main body in the reactor, the temperature of the coil is not directly detected. In other words, in JP2019-004066A, even when the detected temperature of the end face of the core main body is within a normal range, the temperature of the coil may be higher than its normal range, making it impossible to preclude occurrence of an interlayer short-circuit.

Therefore, a reactor that can accurately determine the temperature of a coil, and a coil case used in such a reactor are desired.

According to a first aspect of the present disclosure, there is provided a reactor including an outer peripheral iron core; and at least three iron core coils configured to be in contact with or connected to an inner surface of the outer peripheral iron core, wherein each of the at least three iron core coils is configured of each of iron cores and each of coils mounted on the iron cores, and each of the coils configured of a flat wire that is wound at least once; a radial inner end portion of each of the at least three iron cores converges toward a center of the outer peripheral iron core; and each of gaps allowed to be magnetically connected is formed between an iron core of the at least three iron cores and another iron core adjacent to the one iron core, and the radial inner end portions of the at least three iron cores are spaced apart from each other via the gaps allowed to be magnetically connected, and a temperature detector provided to be in surface contact with a wide face of the flat wire constituting at least one coil of the at least three coils is further provided.

In the first aspect, since the temperature detector is in surface contact with the wide face of the flat wire constituting the coil, a thermal resistance between the temperature detector and the coil is reduced, hence, a temperature change of the coil can be promptly detected. Thereby, it can be quickly ascertained whether or not an interlayer short-circuit has occurred in the coil. By sandwiching a thermally conductive material, such as silicon, an adhesive, or the like, between the temperature detector and the coil to prevent formation of an air layer, it is possible to reduce the thermal resistance between the temperature detector and the coil in order to detect a temperature change of the coil more quickly.

The objects, features and advantages of the present invention will become more apparent from the following description of embodiments in connection with the accompanying drawings.

### BRIEF DESCRIPTION OF THE DRAWINGS

FIG. 1A is a cross-sectional view of a core main body included in a reactor according to a first embodiment.

FIG. 1B a perspective view of the reactor illustrated in FIG. 1A.

FIG. 2A is a top view of a core main body included in a reactor according to a second embodiment.

FIG. 2B is a perspective view of a coil case viewed from a radially inner side of the reactor.

FIG. 2C is a perspective view of the coil case viewed from a radially outer side of the reactor.

FIG. 3 is a perspective view of the coil case and the coil.

FIG. 4A is a partial cross-sectional view of the coil case.

FIG. 4B is a partial cross-sectional view of a coil case according to another embodiment.

FIG. 5A is a cross-sectional view of the coil case.

FIG. 5B is a partial perspective view of the coil case.

FIG. 6 is a partial perspective view of the reactor.

FIG. 7A is a top view of a core main body of a reactor according to a third embodiment.

FIG. 7B is a top view of a core main body of a reactor according to a fourth embodiment.

### DETAILED DESCRIPTION

Embodiments of the present invention will be described below with reference to the accompanying drawings. Throughout the drawings, corresponding components are denoted by common reference numerals.

While in the following description, a three-phase reactors are primarily described by way of example, an application of the present disclosure is not limited to the three-phase reactors and the present disclosure is widely applicable to a multi-phase reactor in which a constant inductance is required for each phase. In addition, the reactors according to the present disclosure are not limited to that provided on a primary side and a secondary side of an inverter in an industrial robot or a machine tool, and can be applied to various apparatuses.

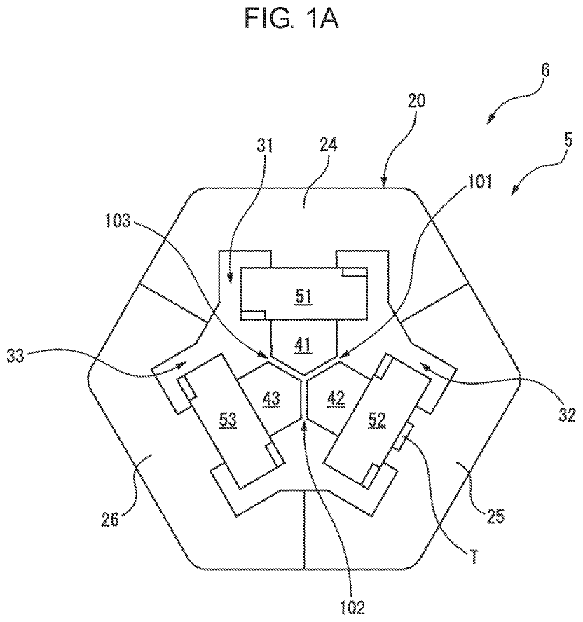

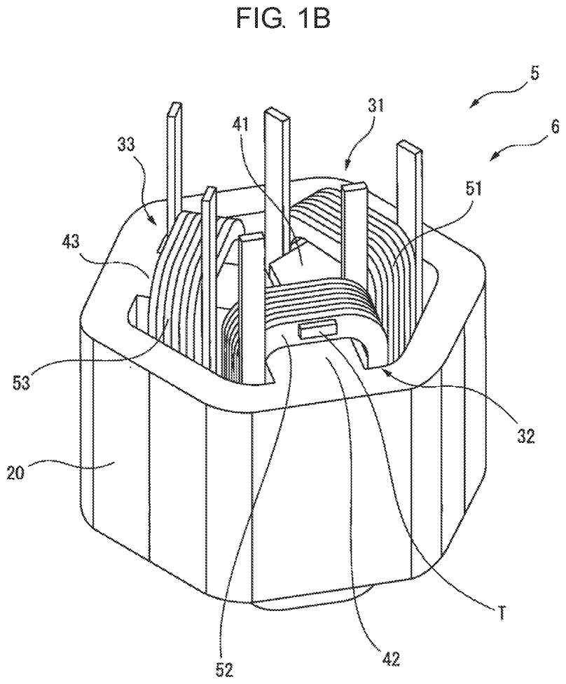

FIG. 1A is a cross-sectional view of a core main body included in a reactor according to a first embodiment. FIG. 1B is a perspective view of the reactor illustrated in FIG. 1A. As illustrated in FIGS. 1A and 1B, a core main body 5 of a reactor 6 includes an outer peripheral iron core 20 and three iron core coils 31 to 33 disposed at the inside of the outer peripheral iron core 20. In FIG. 1, the iron core coils 31 to 33 are disposed at the inside of the outer peripheral iron core 20 having a substantially hexagonal shape. These iron core coils 31 to 33 are arranged at equal intervals in a circumferential direction of the core main body 5.

The outer peripheral iron core 20 may have another rotationally symmetric shape, e.g., a circular shape. Additionally, the number of iron core coils may be a multiple of three. In that case, the reactor 6 can be used as a three-phase reactor.

As can be seen from the drawing, the iron core coils 31 to 33 respectively include: iron cores 41 to 43 extending only in a radial direction of the outer peripheral iron core 20; and coils 51 to 53 mounted on the iron cores respectively. In other drawings, illustration of the coils 51 to 53 may be omitted for the sake of simplicity.

The outer peripheral iron core 20 is composed of a plurality of outer peripheral iron core portions, for example, three outer peripheral iron core portions 24 to 26, which are separated from one another in the circumferential direction. The outer peripheral iron core portions 24 to 26 are formed integrally with the iron cores 41 to 43, respectively. The outer peripheral iron core portions 24 to 26 and the iron cores 41 to 43 are formed by stacking a plurality of magnetic sheets, e.g., steel sheets, carbon steel sheets, or electromagnetic steel sheets, or are formed of a dust core. Forming the outer peripheral iron core 20 with use of the plurality of outer peripheral iron core portions 24 to 26 in this way enables easier manufacturing of the outer peripheral iron core 20 described above, even when the outer peripheral iron core 20 is large. The number of iron cores 41 to 43 and the number of outer peripheral iron core portions 24 to 26 do not necessarily have to be equal to each other.

In addition, each of radial inner end portions of the iron cores 41 to 43 is positioned near the center of the outer peripheral iron core 20. In the drawing, the radial inner end portion of each of the iron cores 41 to 43 converges toward the center of the outer peripheral iron core 20 and has a tip angle of about 120 degrees. The radial inner end portions of the iron cores 41 to 43 are spaced apart from each other via gaps 101 to 103 allowed to be magnetically connected.

In other words, the radial inner end portion of the iron core 41 is spaced apart from the radial inner end portions of the respective two adjacent iron cores 42 and 43 via the gaps 101 and 103. The same applies to the other iron cores 42 and 43. The gaps 101 to 103 are equal to one another in dimension.

As described above, the configuration illustrated in FIG. 1A does not require a central iron core positioned at the center of the core main body 5, hence, the core main body 5 can be reduced in weight and formed easily. In addition, the three iron core coils 31 to 33 are surrounded by the outer peripheral iron core 20, hence, magnetic fields generated from the coils 51 to 53 do not leak to the outside of the outer peripheral iron core 20. The gaps 101 to 103 can be provided having any thickness and at low cost, which is advantageous in design, compared to reactors with configurations in the related art.

In addition, the core main body 5 of the present disclosure has a smaller difference in magnetic path length between phases than that in a reactor having a configuration in the related art. Thus, in the present disclosure, it is also possible to reduce inductance imbalance occurring due to the difference in magnetic path length.

As can be seen with reference to FIG. 1B, each of the coils 51 to 53 mounted respectively on the iron cores 41 to 43 is a flat wire coil formed by winding at least once a single conductive wire having a rectangular cross section, i.e., a flat wire. Since the cross section of the flat wire is rectangular, the flat wire includes a pair of wide faces parallel to each other and a pair of narrow faces parallel to each other, with the pair of wide faces and the pair of narrow faces being perpendicular to each other. Therefore, the wide faces of the flat wire are exposed respectively to end faces of the coils 51 to 53.

In the first embodiment, a temperature detector T, e.g., a temperature sensor, is attached to the end surface of one of the coils, e.g., the coil 52. More precisely, the temperature detector T is attached to the wide face of the flat wire constituting the coil 52. The temperature detector T is connected wired or wirelessly to an external control device (not illustrated), e.g., a CNC, a converter, an inverter, an I/O, or a computer.

When the reactor 6 is driven, the coils 51 to 53 generate heat. In the present invention, since the temperature detector T is in surface contact with the wide face of the coil 52, the temperature of the coil 52 can be accurately detected. Thus, by comparing a detected temperature with a predetermined threshold value, it is possible to accurately ascertain whether or not an interlayer short-circuit has occurred in the coil 52. By sandwiching a thermally conductive material, such as silicon, an adhesive, or the like, between the temperature detector T and the coil 52 to prevent formation of an air layer, it is also possible to reduce a thermal resistance between the temperature detector T and the coil, and to detect a temperature change of the coil more promptly. It is also possible to ascertain a load state of the reactor 6.

In FIGS. 1A and 1B, the temperature detector T is attached to the end face of the coil 52 located radially on the outer side of the reactor 6. However, the temperature detector T may be attached to the end face of the coil 52 located radially on the inner side of the reactor 6. Generally, the temperature is higher at the radially inner side end face of the coil 52, where air flow is more easily stagnant, than at the end face on the radially outer side. For this reason, when the temperature detector T is attached to the end face on the radially inner side of the coil 52, it is possible to ascertain with sufficient allowance whether or not an interlayer short-circuit occurs in the coil 52. Further, the temperature detector T may also be provided on at least one of the other coils 51 and 53.

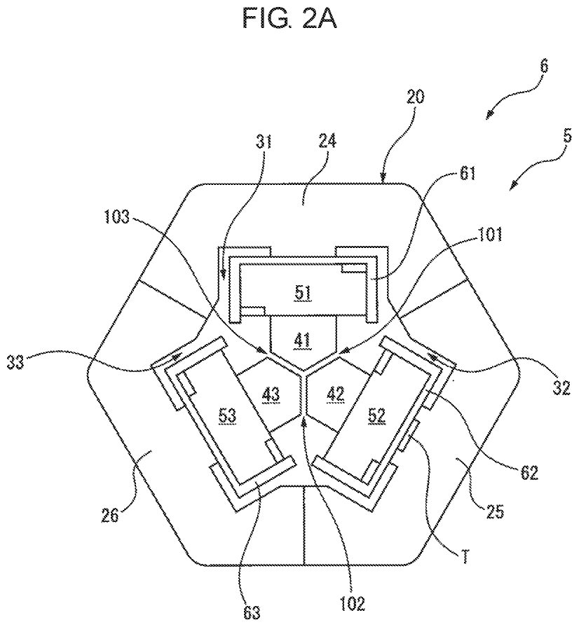

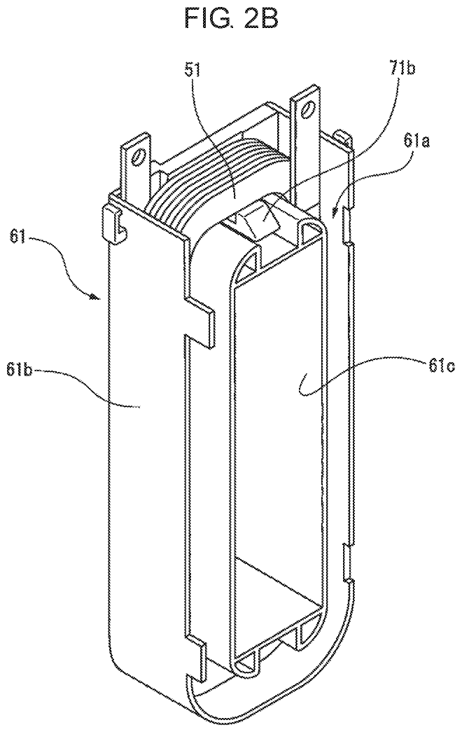

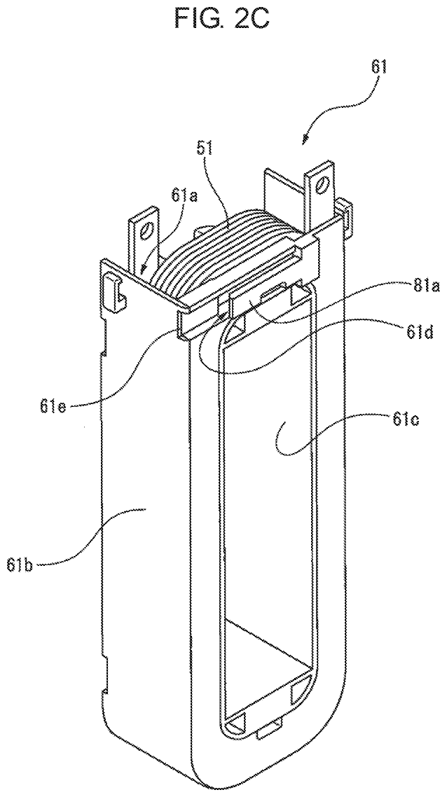

FIG. 2A is a top view of a core main body included in a reactor according to a second embodiment. The second embodiment is different from the first embodiment in that the at least three coils 51 to 53 are housed in coil cases 61 to 63, respectively. The coil cases 61 to 63 are preferably formed from a non-magnetic material, e.g., resin, or insulating paper.

FIGS. 2B and 2C are perspective views of the coil case viewed from a radially inner side and radially outer side of the reactor, respectively. In these drawings, only the coil case 61 is illustrated as a representative, but the other coil cases 62, 63, and (64) have the same configuration. The coil case 61 includes a housing 61b in which a top face and a radially inner side face are open, and a hollow protrusion 61c protruding toward the radially inner side from a radially outer side end face of the housing 61b.

A space between the housing 61b and the hollow protrusion 61c is a coil housing portion 61a having a shape suitable for housing the coil 51. Further, as described later, the hollow portion of the hollow protrusion 61c has a shape suitable for receiving the iron core 41. Referring to FIG. 2C, a temperature detector housing portion 61d is formed near an upper end on an end face of the coil case 61 on the radially outer side of the reactor 6.

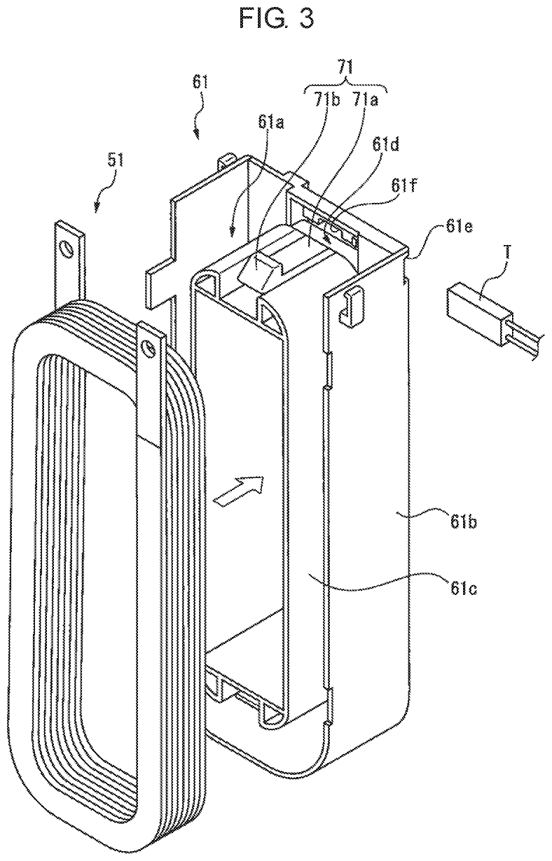

The temperature detector T is housed in the temperature detector housing portion 61d. FIG. 3 is a perspective view of the coil case and the coil. As illustrated in FIG. 3, an inlet 61e of the temperature detector housing portion 61d is formed as a notch at an edge portion of the housing 61b. The temperature detector T is slid from the inlet 61e in a direction perpendicular to the radial direction of the reactor 6 and is housed in the temperature detector housing portion 61d.

The temperature detector housing portion 61d is formed such that the temperature detector T at least partially comes into surface contact with the wide face of the flat wire that constitutes the coil 51. Therefore, it can be understood that by using the coil case 61 provided with such a temperature detector housing portion 61d, the temperature detector T is easily brought into surface contact with the wide face of the flat wire constituting the coil 51.

For this purpose, an opening 61f or a notch is preferably formed at least partially on a wall portion of the temperature detector housing portion 61d adjacent to the coil 51. Note that the temperature detector housing portion 61d may be formed at another portion of the housing 61b, where the temperature detector T is at least partially brought into surface contact with the wide face of the flat wire constituting the coil 51. Note that the temperature detector T may be housed only in the coil case 61, or may be housed in at least one of the coil cases 61 to 63. Further, the coil cases 61 to 63 themselves are also included in the scope of the present invention.

As can be seen with reference to FIG. 3, a first snap engaging section 71, which is preferably made of resin, is provided on a portion of the hollow protrusion 61c. The first snap engaging section 71 includes a first plate spring portion 71a that extends in a cantilever manner to the radially inner side from an end face of the housing 61b located on the radially outer side of the reactor 6, and a first retainer portion 71b provided at a leading end of the first plate spring portion 71a.

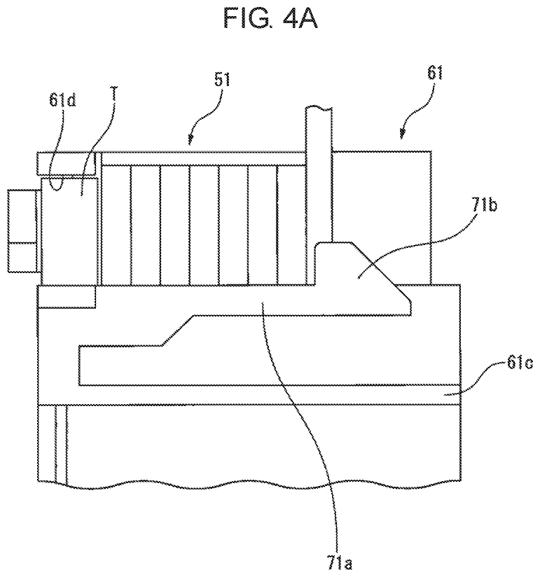

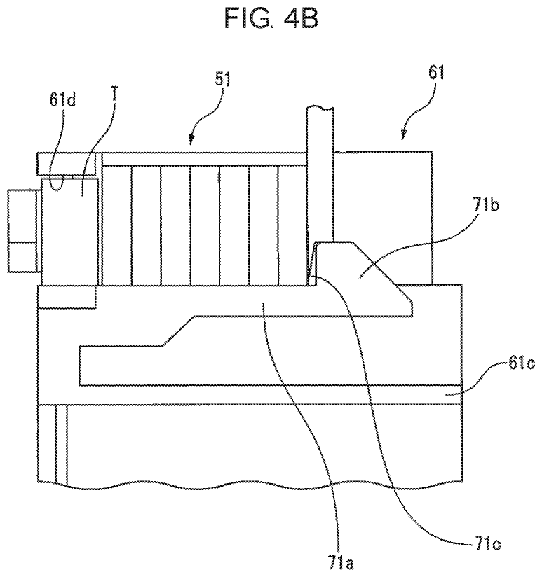

FIG. 4A is a partial cross-sectional view of the coil case. As can be seen with reference to FIGS. 3 and 4A, when the coil 51 is moved to the radially outer side of the reactor 6 (arrow direction in FIG. 3), the first retainer portion 71b is pressed by the one end face of the coil 51, and the first plate spring portion 71a curves downward. When the coil 51 is housed in the coil housing portion 61a, the first plate spring portion 71a returns to an original position, and the first retainer portion 71b engages the other end face of the coil 51. In other words, the coil 51 is snap-engaged with the coil housing portion 61a by the first snap engaging section 71. Thus, the coil 51 can be prevented from falling out of the coil housing portion 61a.

FIG. 4B is a partial cross-sectional view of a coil case according to another embodiment. In FIG. 4B, a pressing portion 71c is provided on a face of the first retainer portion 71b facing the coil 51 housed in the coil housing portion 61a. The pressing portion 71c may be an inclined face inclining upward from the coil 51 toward the first retainer portion 71b. By the pressing portion 71c, the coil 51 is pressed, to the radially outer side of the reactor 6, against the temperature detector T. Thus, the temperature detector T can more accurately detect the temperature of the coil 51. Further, the pressing portion 71c may have another shape that presses the coil 51, to the radially outer side of the reactor 6, against the temperature detector T.

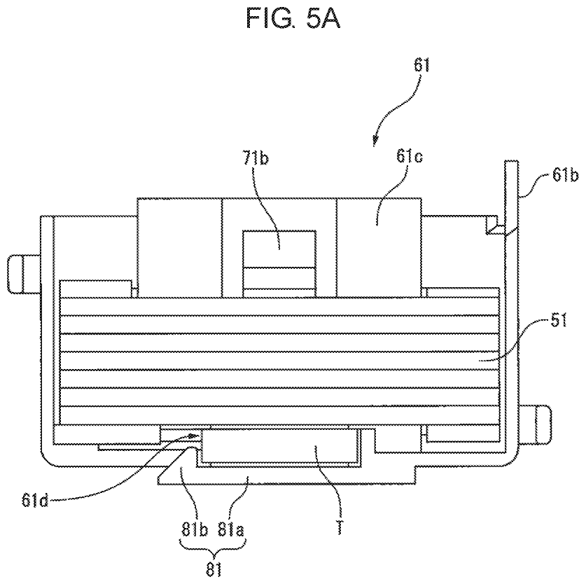

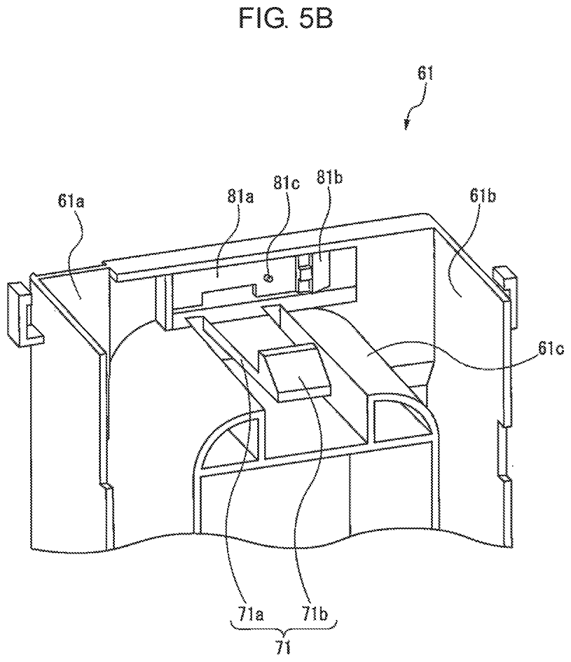

FIG. 5A is a cross-sectional view of the coil case and FIG. 5B is a partial perspective view of the coil case. As described above, the temperature detector T is housed in the temperature detector housing portion 61d. A second snap engaging section 81, which is preferably made of resin, is provided on a portion of the housing 61b. The second snap engaging section 81 includes a second plate spring portion 81a that extends in a cantilever manner parallel to the end face of the housing 61b located on the radially outer side of the reactor 6, and a second retainer portion 81b provided at a leading end of the second palate spring portion 81a.

When the temperature detector T is moved toward the temperature detector housing portion 61d, the second retainer portion 81b is pressed by one end face of the temperature detector T, and the second plate spring portion 81a curves to the radially outer side of the reactor 6. When the temperature detector T is housed in the temperature detector housing portion 61d, the second plate spring portion 81a returns to an original position, and the second retainer portion 81b engages another end face of the temperature detector T. In other words, the temperature detector T is snap-engaged with the temperature detector housing portion 61d by the second snap engaging section 81. Thus, the temperature detector T can be prevented from falling out of the temperature detector housing portion 61d.

Additionally, as illustrated in FIG. 5B, a protrusion 81c may be provided on an inner face of the second plate spring portion 81a. The protrusion 81c extends to the radially inner side of the reactor 6. When the temperature detector T is housed in the temperature detector housing portion 61d, the protrusion 81c serves to press the temperature detector T against the coil 51. Thus, it can be understood that the temperature detector T can more accurately detect the temperature of the coil 51.

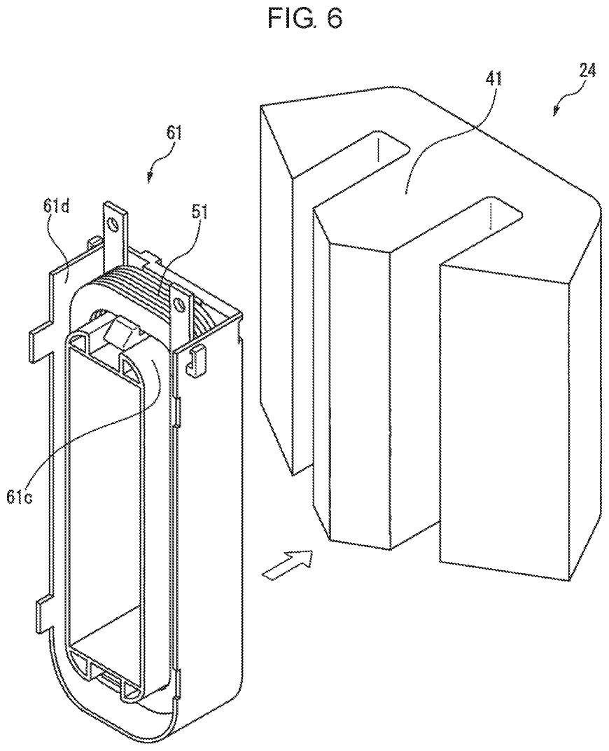

FIG. 6 is a partial perspective view of the reactor. As illustrated in FIG. 6, the coil case 61 in which the coil 51 is housed is moved toward the outer peripheral iron core portion 24. In this way, the iron core 41 integrated with the outer peripheral iron core portion 24 is inserted into the hollow protrusion 61c of the coil case 61. Thereby, the coil 51 can be mounted on the iron core 41. After the other coils 52 and 53 are also housed in the corresponding coil cases 62 and 63, these coils are also mounted to the iron cores 42 and 43 of the outer peripheral iron core portion 25 and 26, respectively. Thereafter, the outer peripheral iron core portions 24 to 26 are assembled with one another, thereby forming the reactor 6 illustrated in FIG. 2A.

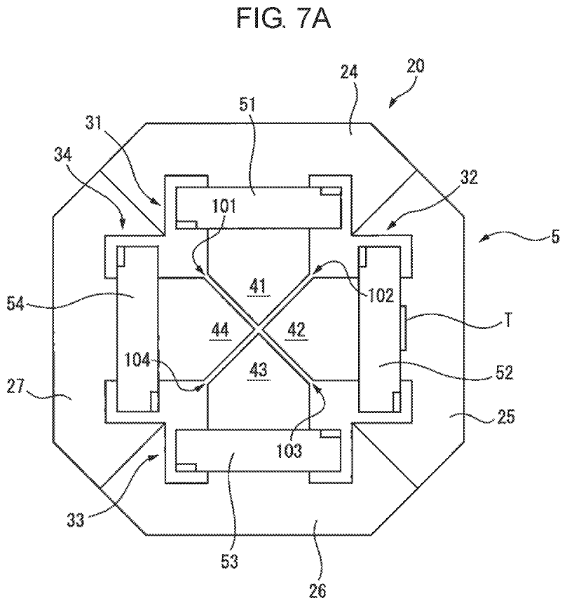

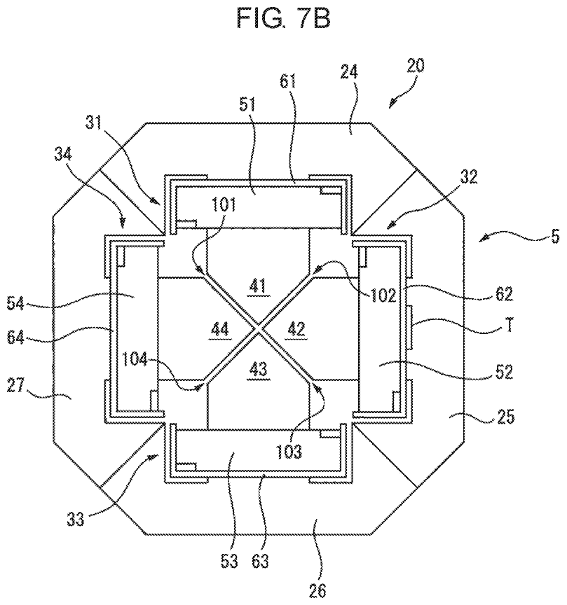

FIG. 7A is a top view of a core main body of a reactor according to a third embodiment. The core main body 5 illustrated in FIG. 7A includes the outer peripheral iron core 20 having a substantially octagonal shape and four iron core coils 31 to 34 similar to those above-described and disposed inside the outer peripheral iron core 20. These iron core coils 31 to 34 are arranged at equal intervals in a circumferential direction of the core main body 5. In addition, the number of iron cores is preferably an even number of four or more, and thus the reactor having the core main body 5 can be used as a single-phase reactor.

As can be seen from the drawing, the outer peripheral iron core 20 is formed of four outer peripheral iron core portions 24 to 27, which are separated from one another circumferentially. The iron core coils 31 to 34 respectively include iron cores 41 to 44 extending radially and coils 51 to 54 mounted on the iron cores respectively. Each of the iron cores 41 to 44 has a radial outer end portion formed integrally with each of the outer peripheral iron core portions 21 to 24. The number of the iron cores 41 to 44 and the number of the outer peripheral iron core portions 24 to 27 may not have to be necessarily equal to each other.

In addition, each of the iron cores 41 to 44 has a radial inner end portion positioned near the center of the outer peripheral iron core 20. In FIG. 7A, the radial inner end portion of each of the iron cores 41 to 44 converges toward the center of the outer peripheral iron core 20 and has a tip angle of about 90 degrees. The radial inner end portions or the iron cores 41 to 44 are spaced apart from one another via gaps 101 to 104 allowed to be magnetically connected.

In FIG. 7A, the temperature detector T, e.g., a temperature sensor, is attached to the wide face of the flat wire constituting, for example, the coil 52. Thus, the temperature of the coil 52 can be accurately detected. Therefore, the same effect as described above can be obtained.

FIG. 7B is a top view of a core main body of a reactor according to a fourth embodiment. The fourth embodiment is different from the third embodiment in that at least the four coils 51 to 54 are housed in the coil cases 61 to 64 respectively, similarly to those described above.

In FIG. 7B, the temperature detector T, e.g., a temperature sensor, is attached to one coil case, for example, the roil case 62, in the same manner as described above. By using the coil case 62, the temperature detector T can be easily brought into surface contact with the wide face of the coil 52, such that the same effect as described above can be obtained.

### Aspects of the Disclosure

According to a first aspect, there is provided a reactor including: an outer peripheral iron core (20); and at least three iron core coils (31 to 34) configured to be in contact with or connected to an inner surface of the outer peripheral iron core, wherein each of the at least three iron core coils is configured of each of iron cores (41 to 44) and each of coils (51 to 54) mounted on the iron cores, and each of the coils is configured of a flat wire that is wound at least once; a radial inner end portion of each of the at least three iron cores converges toward a center of the outer peripheral iron core; and each of gaps (101 to 104) allowed to be magnetically connected is formed between an iron core of the at least three iron cores and another iron core adjacent to the one iron core, and the radial inner end portions of the at least three iron cores are spaced apart from one another via the gaps allowed to be magnetically connected, and a temperature detector (T) provided to be in surface contact with a wide face of the flat wire constituting at least one coil of the at least three coils is further provided.

According to a second aspect, in the first aspect, the reactor further includes at least three coil cases (61 to 64) each having a coil housing portion (61a) configured to house each of the at least three coils, in which each of the at least three coil cases includes a temperature detector housing portion (61d) configured to house the temperature detector.

According to a third aspect, in the second aspect, the coil housing portion includes a first snap engaging section (71) configured to have the coil snap-engage with the coil housing portion.

According to a fourth aspect, in the third aspect, the first snap engaging section includes a pressing portion (71c) configured to press the coil against the temperature detector.

According to a fifth aspect, in any one of the second to fourth aspects, the temperature detector housing portion includes a second snap engaging section (81) configured to have the temperature detector snap-engage with the temperature detector housing portion.

According to a sixth aspect, in the fifth aspect, the second snap engaging section includes a protrusion (81c) configured to press the temperature detector against the coil.

According to a seventh aspect, any one of the first to sixth aspects is configured such that the number of the at least three iron core coils is a multiple of 3.

According to an eighth aspect, any one of the first to sixth aspects is configured such that the number of the at least three iron core coils is an even number of 4 or more.

According to an ninth aspect, there is provided coil cases (61 to 64) each including: a coil housing portion (61a) in which a coil configured by winding a flat wire at least once is to be housed; and a temperature detector housing portion (61d) in which a temperature detector configured to detect a temperature of the coil is to be housed, wherein the temperature detector housing portion is configured such that the temperature detector comes into surface contact with a wide face of the flat wire constituting the coil housed in the coil housing portion.

According to a tenth aspect, in the ninth aspect, the coil housing portion includes a first snap engaging section (71) configured to have the coil snap-engage with the coil housing portion.

According to an eleventh aspect, in the tenth aspect, the first snap engaging section includes a pressing portion (71c) configured to press the coil against the temperature detector.

According to a twelfth aspect, in any of the ninth to eleventh aspects, the temperature detector housing portion includes a second snap engaging section (81) configured to have the temperature detector snap-engage with the temperature detector housing portion.

According to a thirteenth aspect, in the twelfth aspect, the second snap engaging section includes a protrusion (81c) configured to press the temperature detector against the coil.

### Effects of Aspects

In the first aspect, a temperature change of the coil can be promptly detected because the temperature detector is in surface contact with the wide face of the flat wire constituting the coil. Accordingly, it can be promptly ascertained whether or not an interlayer short-circuit has occurred in the coil, and the reactor can be protected before occurrence of deterioration of an insulating member around the coil due to heat.

In the second aspect, the temperature detector is easily brought into surface contact with the wide face of the coil by using the coil case.

In the third aspect, the first snap engaging section can prevent the coil from falling out of the coil housing portion.

In the fourth aspect, since the coil is pressed the temperature detector, the temperature of the coil can be detected more accurately.

In the fifth aspect, by the second snap engaging section, the temperature detector can be prevented from falling out of the temperature detector housing portion.

In the sixth aspect, since the temperature detector is pressed against the coil by the protrusion, the temperature of the coil can be detected more accurately.

In the seventh aspect, the reactor can be used as a three-phase reactor.

In the eighth aspect, the reactor can be used as a single-phase reactor.

In the ninth aspect, the temperature detector to be housed in the temperature detector housing portion comes into surface contact with the wide face of the flat wire constituting the coil to be housed in the coil housing portion. Thus, a temperature change of the coil can be promptly detected. As a result, it can be promptly ascertained whether or not an interlayer short-circuit has occurred in the coil.

In the tenth aspect, by the first snap engaging section, the coil can be prevented from falling out of the coil housing portion.

In the eleventh aspect, since the coil is pressed by the temperature detector, a temperature of the coil can be detected more accurately.

In the twelfth aspect, the temperature detector can be prevented from falling out of the temperature detector housing portion by the second snap engaging section.

In the thirteenth aspect, since the temperature detector is pressed against the coil by the protrusion, the temperature of the coil can be detected more accurately.

While the invention has been described with reference to specific embodiments, it will be understood, by those skilled in the art, that various changes or modifications may be made thereto without departing from the scope of the claims described later.

1. A reactor comprising:
an outer peripheral iron core; and
at least three iron core coils configured to be in contact with or connected to an inner surface of the outer peripheral iron core, wherein
each of the at least three iron core coils is configured of each of iron cores and each of coils mounted on the iron cores, and each of the coils is configured of a flat wire that is wound at least once;
a radial inner end portion of each of the at least three iron cores converges toward a center of the outer peripheral iron core; and
each of gaps allowed to be magnetically connected is formed between an iron core of the at least three iron cores and another iron core adjacent to the one iron core, and the radial inner end portions of the at least three iron cores are spaced apart from one another via the gaps allowed to be magnetically connected, and
a temperature detector provided to be in surface contact with a wide face of the flat wire constituting at least one coil of the at least three coils is further provided.

2. The reactor of claim 1, further comprising at least three coil cases each having a coil housing portion configured to house each of the at least three coils, wherein
each of the at least three coil cases includes a temperature detector housing portion configured to house the temperature detector.

3. The reactor of claim 2, wherein
the coil housing portion includes a first snap engaging section configured to have the coil snap-engage with the coil housing portion.

4. The reactor of claim 3, wherein
the first snap engaging section includes a pressing portion configured to press the coil against the temperature detector.

5. The reactor of claim 2, wherein
the temperature detector housing portion includes a second snap engaging section configured to have the temperature detector snap-engage with the temperature detector housing portion.

6. The reactor of claim 5, wherein
the second snap engaging section includes a protrusion configured to press the temperature detector against the coil.

7. The reactor of claim 1, wherein
the number of the at least three iron core coils is a multiple of 3.

8. The reactor of claim 1, wherein
the number of the at least three iron core coils is an even number of 4 or more.

9. A coil case comprising:
a coil housing portion in which a coil configured by winding a flat wire at least once is to be housed; and
a temperature detector housing portion in which a temperature detector configured to detect a temperature of the coil is to be housed, wherein
the temperature detector housing portion is configured such that the temperature detector comes into surface contact with a wide face of the flat wire constituting the coil housed in the coil housing portion.

10. The coil case of claim 9, wherein
the coil housing portion includes a first snap engaging section configured to have the coil snap-engage with the coil housing portion.

11. The coil case of claim 10, wherein
the first snap engaging section includes a pressing portion configured to press the coil against the temperature detector.

12. The coil case of claim 9, wherein
the temperature detector housing portion includes a second snap engaging section configured to have the temperature detector snap-engage with the temperature detector housing portion.

13. The coil case of claim 12, wherein
the second snap engaging section includes a protrusion configured to press the temperature detector against the coil.
